(19) United States
(12) Patent Application Publication
(10) Pub. No.: US 2007/0220266 A1
(43) Pub. Date: Sep. 20, 2007

(54) SECURITY MONITORING SYSTEM AND METHOD FOR NETWORK DISTRIBUTION OF DIGITAL CONTENT

(75) Inventors: Robin Ross Cooper, La Mesa, CA (US); Michael R. Beatty, Carlsbad, CA (US)

Correspondence Address: PROCOPIO, CORY, HARGREAVES & SAVITCH LLP, 530 B STREET, SUITE 2100, SAN DIEGO, CA, 92101, US

(73) Assignee: Verimatrix, Inc.

(21) Appl. No.: 11/680,492

(22) Filed: Feb. 28, 2007

Related U.S. Application Data
(60) Provisional application No. 60/779,059, filed on Mar. 3, 2006.

(51) Int. Cl. H04L 9/00

(52) U.S. Cl. 713/176

(57) ABSTRACT

In a method of monitoring the distribution of digital content files, transaction information regarding transfer of a selected digital content file stored at a distribution provider to a distributor is obtained by a transaction monitoring module and analyzed to detect whether the transfer is valid and associated with a valid security device for the transfer. A report is generated if a security breach is detected and is used by a piracy insurance provider to assess risks in connection with a piracy insurance policy issued to the distribution provider. The security device may be an encrypted watermark or digital signature using a digital certificate associated with the distributor to which the file is transferred.

### RELATED APPLICATION

The present application claims the benefit of co-pending U.S. provisional patent application No. 60/779,059 filed Mar. 3, 2006, which is incorporated herein by reference in its entirety.

### BACKGROUND

1. Field of the Invention

The present invention relates to a security monitoring system and method for monitoring the security of digital content files distributed over one or more networks.

2. Related Art

Digital piracy and computer hacking is a common problem, particularly now that digital content is often made available to the public over the Internet. Digital piracy occurs at content creation sites, content preparation sites, as well as in content distribution networks.

Piracy or theft of digital content is a particular problem when a major movie studio is about to release a new, high profile movie. The theatrical release of a movie is negatively impacted with lower receipts if there is any significant occurrence of piracy prior to the release date. Piracy also occurs when digital content is distributed over a network. There are security techniques available to secure digital content files, including cryptography, watermarking, and the like. In spite of these practices, digital piracy can still occur as a result of hacking, theft and the like.

The practice of providing insurance to the owners of property has been in existence for hundreds of years. The fundamentals for the insurance business are based upon the mathematical likelihood that a disaster may (or may not) strike and the insurer's willingness to accept the risk spread over a significant number of policy holders. Major content owners globally want to secure their digital creations while offering new and better experiences for the end consumer, and would like to be able to obtain insurance against the risks of digital piracy. However, insurance companies have traditionally been unwilling to provide piracy insurance due to the difficulty in assessing the risks and adequately monitoring such risks.

Therefore, what is needed is a system and method that reduces or overcomes these significant problems found in the conventional systems as described above.

### SUMMARY

Embodiments described herein provide for a method and system for monitoring the security provided for digital content distributed over one or more networks

According to one aspect, a method of monitoring the security of digital content files during distribution over one or more networks is provided, which comprises the steps of monitoring distribution of an insured digital content file in a distribution chain having a first stage from a content provider to a content distributor and a second stage from a content distributor to a subscriber device, determining whether the insured digital content file at each stage of distribution is secured with at least one valid security device, and generating a report if the insured digital content file is not properly secured with a valid security device.

In one embodiment, the method further comprises searching a public network for pirated copies of the insured digital content file and comparing a watermark payload on any pirated copy located in the search with security devices associated with distribution of authorized copies from the content provider to the content distributor.

In another embodiment, a method of monitoring the security of digital content files distributed over one or more networks is provided, which comprises querying a first data base of a content provider to obtain a first transaction package from the content provider, the first stored transaction package containing information regarding distribution of a selected digital content file from a content provider to a distributor requesting the file, the information including a digital signature of the distributor associated with a unique digital certificate of the distributor assigned by a security system of the content provider, storing the first transaction package at the data base of an insured content authority associated with a piracy insurance provider, searching a public network for pirated copies of the selected digital content file, sending a security breach report to the insured content authority if a pirated copy is detected, comparing a watermark payload associated with the detected pirated copy with the stored first transaction package at the insured content authority, and generating a security report with the result of the comparison.

In one embodiment, the above method may also comprise querying a second data base of a content distributor to obtain a second transaction package from the content distributor, the second transaction package containing information regarding distribution of the selected digital content file from the distributor to a subscriber requesting the file, the information including a digital signature of the subscriber associated with a unique digital certificate of the subscriber assigned by a security system of the distributor. Both the first and second transaction packages are compared with a watermark payload of any detected pirated copy of the selected digital content file if the insured content authority receives a security breach report.

A piracy insurance provider may issue piracy insurance policies to a digital content provider, which may be a movie studio or other content provider, if the provider has digital media security technology in place in order to secure the content of each insured digital content file, and the distributors associated with the content provider who distribute the digital content to valid customers or subscribers have similar security technology in place. The security mechanisms may include encryption using the Public Key Infrastructure (PKI) to issue and revoke digital certificates which are immutable software objects. The public key infrastructure provides for a digital certificate that can identify an individual or an organization. The digital certificates are envelopes that carry two unique keys. These two keys are different from one another. One key is the cryptographic reverse of the other. If one key is used to encrypt a packet of data, the only other key in the universe that can successfully unencrypt the packet is the other key kept within the digital certificate. One key is typically called the public key and the other key is typically called the private key. The public key is shared between the content provider and content distributor. A similar cryptographic security system using public and private keys may be used between the content distributor and the customer purchasing an authorized copy of the digital content file. Additional security mechanisms such as watermarking and digital signatures may be used to enhance security. These security mechanisms are monitored by the security monitoring system to determine validity, and a security breach is reported if a valid security mechanism is not found in connection with a transaction involving an insured digital content file, or if a pirated copy of a distributed digital content file is found on a public network.

The security monitoring system monitors authorized distribution of each insured digital content file to determine if the required security measures are in place when the digital content file is distributed from the digital content provider to the distributor, and also monitors the internet for unauthorized copies of the same content file. If required security measures are not in place, insurance coverage may be terminated or the various parties may be contacted and asked to take care of any security breaches. If unauthorized copies are detected on a public network, the source of the leakage may be determined forensically, and steps may be taken to terminate the unauthorized distribution. The security monitoring system may also determine how many unauthorized downloads have taken place and estimate the damage to the digital content provider as a result of the unauthorized downloads, and then provide damages in the form of a payment to the provider.

According to another aspect, a security monitoring system for monitoring distribution of digital content is provided, which comprises a communication module which communicates with a security system associated with a digital content provider, a transaction monitoring module associated with the communication module which queries the security system to obtain a first transaction package corresponding to delivery of a requested insured digital content file from the digital content provider to a distributor, a data base module which stores transaction packages received by the transaction monitoring module, a piracy watch module connected to a public network which searches the network for pirated copies of the insured digital content file and issues a piracy report to the transaction monitoring module if a pirated copy is detected, and a security verification module associated with the transaction monitoring module which extracts transaction information including a digital signature identifying a digital certificate of a party to the transaction from the first transaction package on receipt of a piracy report and compares the transaction information with a digital signature in a watermark payload of pirated copy of the insured digital content file in order to identify a potential source for the security breach. In one embodiment, the communication module also queries a security system associated with the distributor and obtains a stored second transaction package corresponding to distribution of the insured digital content file from the distributor to a requesting subscriber, the data base module stores the second transaction package, and the verification module extracts transaction information from the second transaction package as well as the first transaction package on receipt of a piracy report, and compares the transaction information from both packages with a watermark payload of the pirated copy.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating one embodiment of a security monitoring system as used in a network distribution chain according to one embodiment;

FIG. 2 is a block diagram of the video content authority system (VCAS) at the digital content provider of FIG. 1;

FIG. 3 is a block diagram illustrating the video content authority system (VCAS) at the video or digital content distributor of FIG. 1;

FIG. 4 is a block diagram illustrating the security measures provided by the VCAS systems at the various network devices in the distribution chain illustrated in FIG. 1;

FIG. 5 is a block diagram illustrating the insurance content authority system of FIG. 1 in more detail; and

FIG. 6 is a flow diagram illustrating an embodiment of a method of providing piracy insurance using the system of FIGS. 1 to 5.

### DETAILED DESCRIPTION

Certain embodiments as disclosed herein provide for a method and system for monitoring security measures as digital content files are distributed. For example, one method and system as disclosed herein allows for monitoring the security provided for insured digital content distributed over one or more networks to verify that a predetermined level of security is present.

After reading this description it will become apparent to one skilled in the art how to implement the invention in various alternative embodiments and alternative applications. However, although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

In the following description, a client device may be any type of device capable of computing and receiving data from a network, such as a set top box (STB), personal computer, game console, cellular phone, personal digital assistant (PDA), personal media player, video equipment such as a digital video receiver (DVR), digital video disc (DVD) player (DVD), compact disc (CD) player, smart card, or the like. In alternative embodiments, the client device may be a movie theater which displays movies to audiences.

A network may refer to a network or combination of networks spanning any geographical area, such as a local area network, wide area network, regional network, national network, and/or global network. The Internet is an example of a current global computer network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communications service (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others.

Also in the following description, a digital content file is a movie or television show in the described embodiments, but may be a music recording or other type of digital content file in alternative embodiments, such as music, games, software, multi-media presentations, images, smells, (and other materials that can be represented digitally). A digital content provider may be the creator of the digital content, such as a movie or motion picture studio or television studio, or may be a content provider which distributes content created by others, such as a home box office or video on demand provider, web provider, international distributor, television network, or amateur content provider. A distributor may be a telephone company, cable television provider, satellite television provider, Internet service provider, or the like which is associated with an access network connected with a group of subscribers or with movie theaters which display movies to customers.

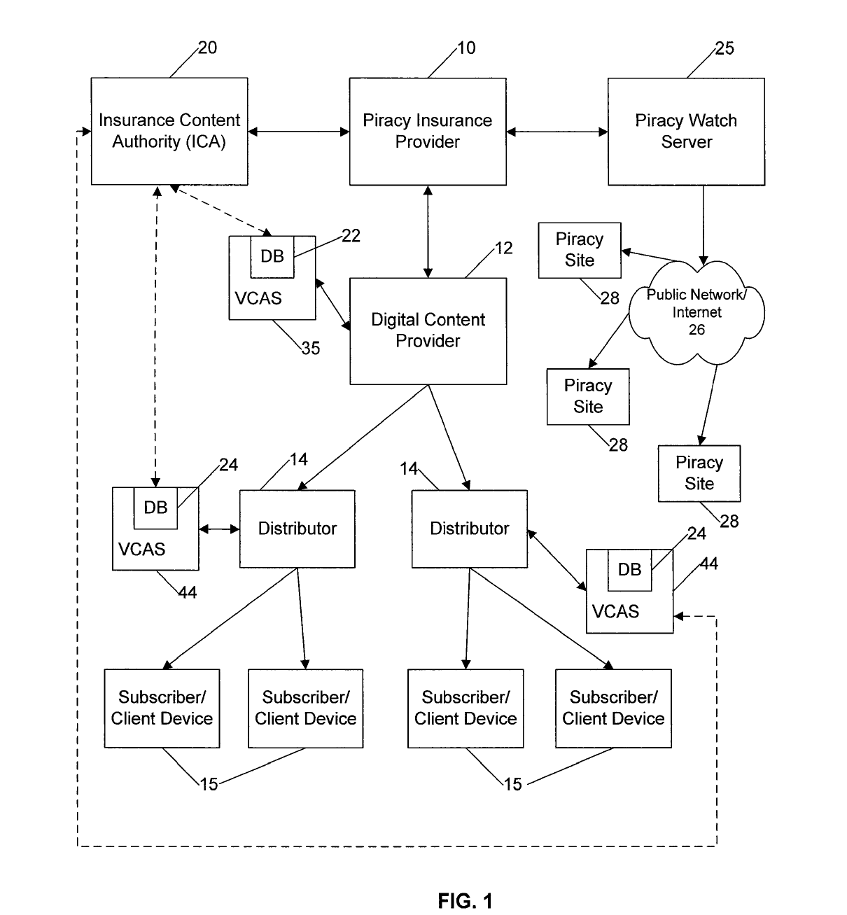

FIG. 1 is a block diagram of one embodiment of a security monitoring system as used to monitor security in a digital content distribution chain or network system which may involve one or more networks. In the exemplary embodiment, the security monitoring system is used by a piracy insurance provider 10 in order to determine whether adequate security measures are in place for an insured digital content file such as a movie, and to cancel insurance or take other measures if adequate security is not detected or security breaches are found. However, the monitoring system may be used by other entities in alternative embodiments.

Piracy insurance provider 10 offers piracy insurance coverage to digital content providers 12 such as major motion picture studios, television studios, or other providers of digital content. The offer of insurance coverage is contingent on the digital content provider 12 having adequate security mechanisms or measures in place for secure transmission of digital content files over a network to one or more authorized distributors 14 which also have security mechanisms in place for secure distribution of the digital content files to end users or client devices. The end users may be individual subscribers in homes, offices or the like, or may be movie theaters which receive new movies from distributors for display to audiences. The digital content files or movies may be distributed from the content provider to the distributors over any suitable network. The distributors each have a network, such as a local access network, for distributing content to the respective group of subscribers, or to the client devices 15 of such subscribers. The insurance offer may also be contingent on the distributors 14 having security measures in place for secure transmission of digital content files to client devices over the distributor network.

The digital content provider 12 has a video content authority system (VCAS) 35 and each digital content distributor 14 is also associated with its own video content authority system (VCAS) 44. Each VCAS 35, 44 is configured to provide protection of ownership rights of digital content files while also providing distribution of the content files to entities that are authorized to receive the digital content files. A security monitoring system communicates with VCAS for monitoring the security of files distributed over the distribution chain illustrated in FIG. 1. The security monitoring system comprises an insurance content authority (ICA) 20 connected to the piracy insurance provider which monitors the distribution chain from an insured content provider to a subscriber/client device to verify secure transmission of insured digital content files from the provider to the distributor and from the distributor to the client device requesting the content, as described in more detail below. Reports are generated in the event of any detected breaches in security, and other security measures may be taken. As illustrated in FIG. 1, the ICA 20 is linked to the data base 22 of the VCAS 35, and periodically queries this data base for records of transactions involving the insured digital content. ICA 20 may also be linked to the VCAS data bases of any other content providers receiving insurance from piracy insurance provider 10. In this embodiment, the ICA 20 is also linked to the VCAS data bases 24 of each distributor or service operator 14. In an alternative embodiment, the ICA 20 may be linked only to the studio VCAS data base or bases 22 and use only transaction information from those data bases for monitoring purposes.

In the illustrated embodiment, the security monitoring system also comprises a piracy watch module 25 connected to the ICA 20 and the piracy insurance provider 10. The piracy watch module 25 has web-based crawler software which scans the Internet 26 for potential digital piracy and monitors known piracy sites 28 for evidence of copies of protected digital content files or movie files. If copies of insured movie files are found on the Internet, the module 25 sends a piracy or security breach report to the ICA 20. The ICA 20 may also receive information from other external sources regarding potential piracy of insured movie files. Either piracy module 25 or the ICA 20 may perform forensic analysis on the pirated copies of insured movie files to find and verify watermark payloads and to determine which party was responsible for the piracy, as described in more detail below.

The piracy watch module may have web crawler software similar to Ranger Online, a sophisticated search engine which is used by the Motion Picture Association of America (MPAA) to track down movies illegitimately on the Web. Ranger and similar crawlers are automated applications that act like Internet search engines but look for movie files stored and transferred on servers. Ranger provides data to the MPAA, which then sends cease-and-desist letters to the Internet service provider hosting an offensive site or user. Other countries are using similar software to detect digital piracy.

Each VCAS 35, 44 is a security system which prevents or deters unauthorized distribution of digital content files. This system may include various protection schemes, for example, proactive protections such as encryption, SSL or VPN technologies, and public key infrastructure (PKI), and reactive protections such as watermarking or steganography, piracy watch systems, or legal action management. In one embodiment, each video content authority system (VCAS) may comprise a Verimatrix Video Content Authority System distributed by Verimatrix Inc. of San Diego, Calif., and described in co-pending application Ser. No. 10/177,263 filed on Jun. 19, 2002, the contents of which are incorporated herein by reference. Other video content security systems may be used in alternative embodiments.

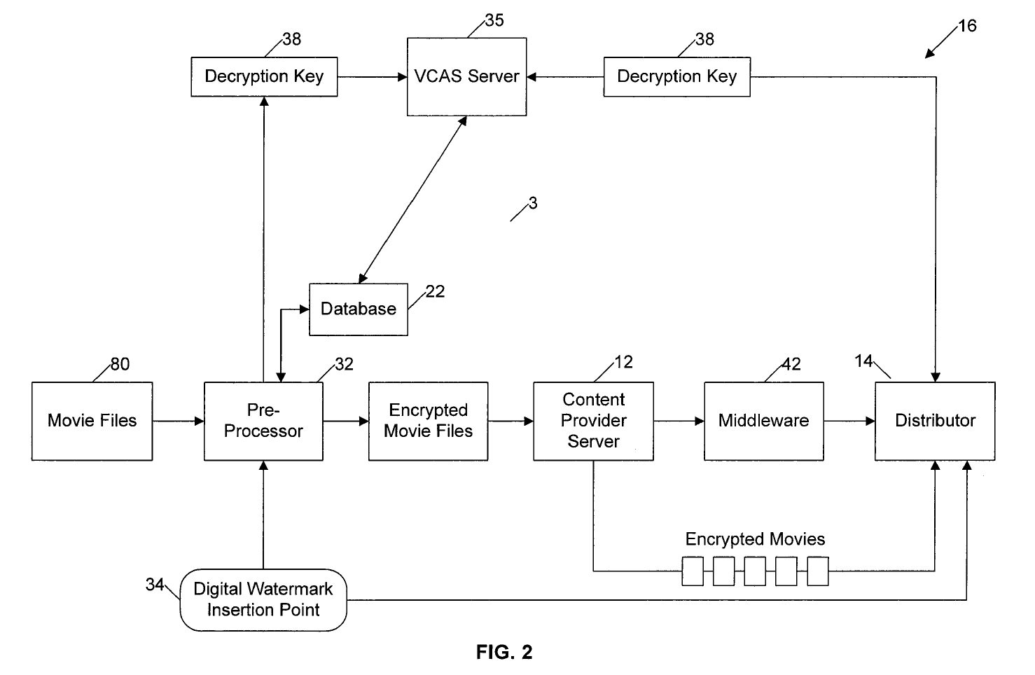

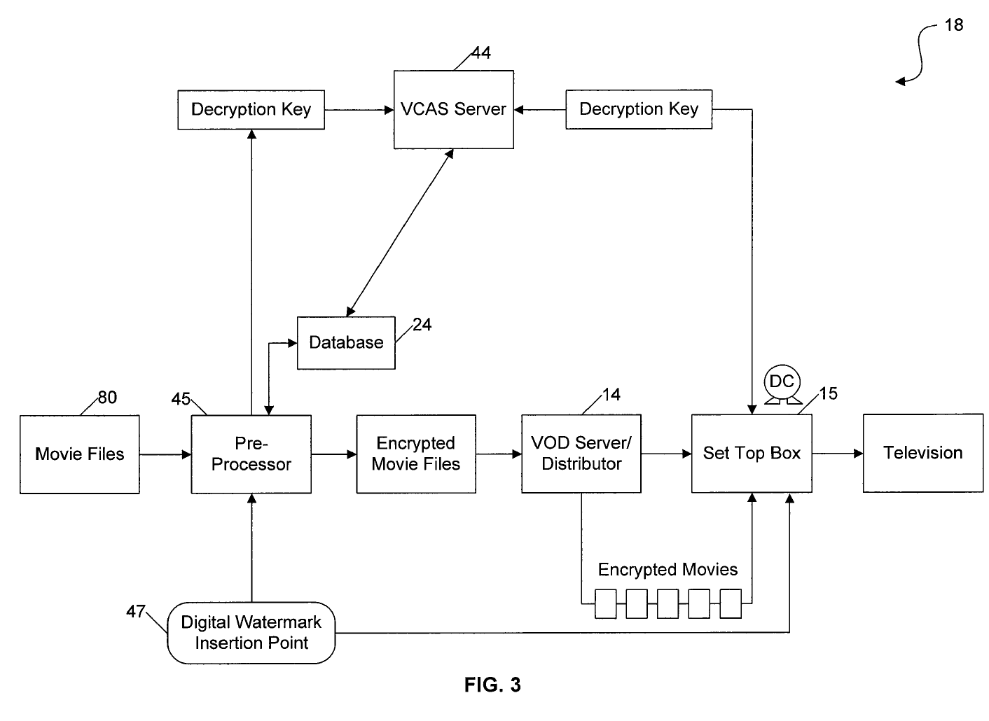

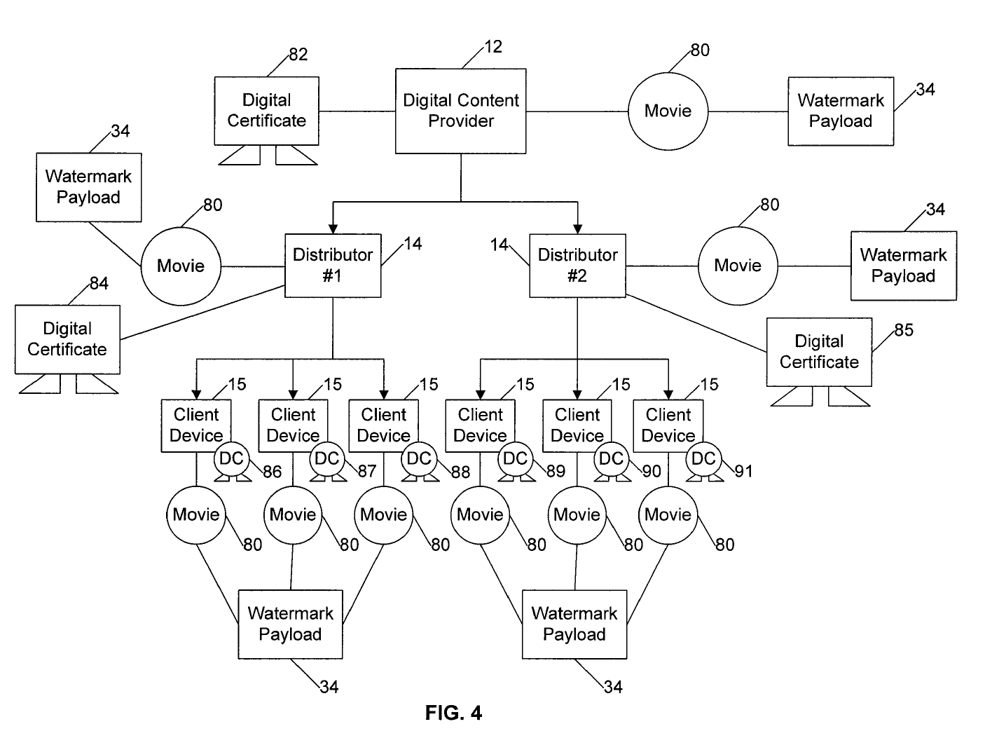

FIGS. 2 and 3 illustrate the video content authority systems 35 and 44 at the digital content provider and distributor, respectively, while FIG. 4 provides more details of the security measures for a movie or digital content file 80 as it is distributed along a distribution chain from a content provider 12 to an end user or client device 15. As illustrated in FIG. 2, digital content files such as movie files at the digital content provider or movie studio are encrypted at pre-processor or encryption server 32 of the VCAS 35, and an encrypted watermark payload 34 is attached to the file. The VCAS software encrypts the movie or digital file and places a discrete and unique watermark payload into files requested by a distributor. The payload of the watermark is a client-specific identifier or transactional ID that can be used to identify the requester of the content. In the case of the content provider, the transactional ID identifies the distributor to which the content is provided. In the case of the distributor, the transactional ID identifies the client device which receives and views the content. The watermark payload may be cryptographically signed with a digital signature using the distributor's private key from the unique digital certificate, to provide further proof of exactly where the content was delivered. The copy of the file delivered to a client device may have two watermark payloads, one containing information identifying the distributor to which the file was originally provided, and one containing information identifying the client device or subscriber receiving and viewing the content.

The VCAS system includes a VCAS server 35 having a data base 22 which stores and issues digital certificates and decryption keys to properly authenticated users. Before the content provider 12, distributor 14, and client devices 15 can use the security system to receive and transmit protected digital content, client registration and authentication is required. Registration and authentication is performed using PKI and X.509 digital certificates issued by a certificate authority. The digital certificates are used to securely encrypt data and provide digital signatures using the public/private key pairs associated with an X.509 certificate. The watermark includes a payload which identifies the content requester, i.e. the distributor to which the movie or file 80 is supplied in the case of VCAS 35, and the client device to which the movie 80 is supplied by the distributor in the case of VCAS 44. The watermark payload is digitally signed by the content requestor. The signature and the watermark payload are then stored in the VCAS database.

As illustrated in FIG. 4, each participant in the distribution chain from the content provider to the end user is associated with a digital certificate 82 to 91, respectively. Each content provider and distributor VCAS has its own X.509 certificate which can be used to identify transactions with that VCAS. The digital content provider VCAS contains the decryption key and distributor watermark associated with each movie distributed. The distributor VCAS stores the decryption key provided by the distributor VCAS for each movie, a transaction record that is signed by the client devices 15 requesting the movie decryption key and also stores the watermark payload signed by the client devices 15.

When a distributor requests a movie or digital content file from the content provider 12, the VCAS 44 first requests the decryption key from the content provider 12. This is done over a secure SSL connection with both client and server side validation of the X.509 certificates. SSL authentication occurs only if a digital certificate has been previously issued by the VCAS 35 to the VCAS 44. The content provider 12 sends the request from VCAS 44 for the decryption key to the VCAS server 35 which creates a transaction record in the VCAS database 22. The transaction record stores the movie id, current date and time the request was received as well as the subject key id of the X.509 certificate associated with the requesting VCAS 44. This transaction record is then returned from the VCAS server 35 to the content provider 12 to the VCAS server 44. VCAS server 44 then uses its X.509 certificate to create a digital signature using the transaction record. The digital signature is sent from VCAS server 44 to content provider 12 to the VCAS server 35 which first verifies the digital signature using the public key associated with the X.509 certificate VCAS server 35 issued to VCAS server 44. Once VCAS server 35 verifies the digital signature of VCAS server 44, it updates the transaction record it previously created in database 22 with the digital signature. VCAS 35 then retrieves the movie decryption key from its database 22 and encrypts the decryption key using the public key of the VCAS server 44. The encrypted decryption key is then sent from VCAS server 35 to content provider 12 to VCAS server 44. VCAS server 44 then stores the encrypted decryption key in its local database.

Once the distributor VCAS 44 has received the decryption key, it then contacts the provider server 12 and requests the encrypted movie. The provider server passes the request to VCAS 35 which generates a watermark payload. The watermark payload is encrypted using the public key of the VCAS 44 server and returned to the provider server 12 which returns the encrypted watermark payload to VCAS 44. VCAS 44 then creates a digital signature of the watermark payload and returns the digital signature back to the provider service 12 which passes the signed payload to VCAS 35. VCAS 35 verifies the digital signature using the public key associated with the X.509 certificate VCAS server 35 issued to VCAS server 44. If the signature is valid, VCAS 35 passes the watermark payload to content provider server 12 which begins the process of decrypting, watermarking and re-encrypting the movie. As the provider server decrypts the movie using the decryption key provided by VCAS 35, it watermarks the movie and then re-encrypts the movie before transmitting the now watermarked and encrypted movie files through middleware system 42 to distributor 14. Data base 22 stores a record of how many copies of each movie or digital content file have been sold, as well as the distributor to which the copies were provided.

Similarly, each distributor 14 is associated with its own VCAS system 44 (see FIG. 3) which has a VCAS server 44 and database 24 which provides X.509 certificates for each authenticated client or subscriber 15 in the distributor's network. The X.509 certificates for clients are generated by the VCAS server 44 and stored in the database 24. When a client device requests the decryption key for a movie, the client first requests a transaction id from VCAS server 44. VCAS server 44 generates a transaction record and stores

When a client 15 requests a movie or digital content file from the content distributor 14, the client 15 first requests the decryption key from the content distributor 14. This is done over a secure SSL connection with both client and server side validation of the X.509 certificates. SSL authentication occurs if a digital certificate has been previously issued by the VCAS 44 to the client 15. The content distributor 14 sends the request from client 15 for the decryption key to the VCAS server 44 which creates a transaction record in the VCAS database 24. The transaction record stores the movie id, current date and time the request was received as well as the subject key id of the X.509 certificate associated with the requesting client 15. This transaction record is then returned from the VCAS server 44 to the content distributor 14 to the client 15. Client 15 then uses its X.509 certificate to create a digital signature using the transaction record. The digital signature is sent from client 15 to content distributor 14 to the VCAS server 44 which first verifies the digital signature using the public key associated with the X.509 certificate VCAS server 44 issued to client 15. Once VCAS server 44 verifies the digital signature of client 15, it updates the transaction record it previously created in database 24 with the digital signature. VCAS 44 then retrieves the movie decryption key from its database 24 and encrypts the decryption key using the public key of the client 15. The encrypted decryption key is then sent from VCAS server 44 to content distributor 14 to client 15.

Once the client 15 has received the decryption key, it then contacts content distributor 14 and requests the encrypted movie. The content distributor 14 passes the request to VCAS 44 which generates a watermark payload. The watermark payload is encrypted using the public key of the client 15 and returned to content distributor 14 which returns the encrypted watermark payload to client 15. Client 15 then creates a digital signature of the watermark payload and returns the digital signature back to the content distributor 14 which passes the signed payload to VCAS 44. VCAS 44 verifies the digital signature using the public key associated with the X.509 certificate VCAS server 44 issued to client 15. If the signature is valid, VCAS 44 passes the watermark payload to content distributor 14 which begins the process of streaming the encrypted movie to client 15. Client 15 uses the decryption key and watermark payload returned to it by VCAS 44 to decrypt and watermark the movie as it is being viewed.

The watermark inserted by the content provider 12 when distributing the content to distributor 14 and the watermark inserted by the client 15 when receiving the content from distributor 14 identifies the distribution path from the content provider to the distributor and from the distributor to the client device. This identifies the transaction so that the origin of any unauthorized or pirated copy of the movie containing the same watermarks can be identified using forensic techniques. The digital signatures required by both the content distributor 14 and the client 15 before either the decryption key or the watermark payload is returned to the content distributor 14 or the client 15 authenticates the requests came from the respective requesters.

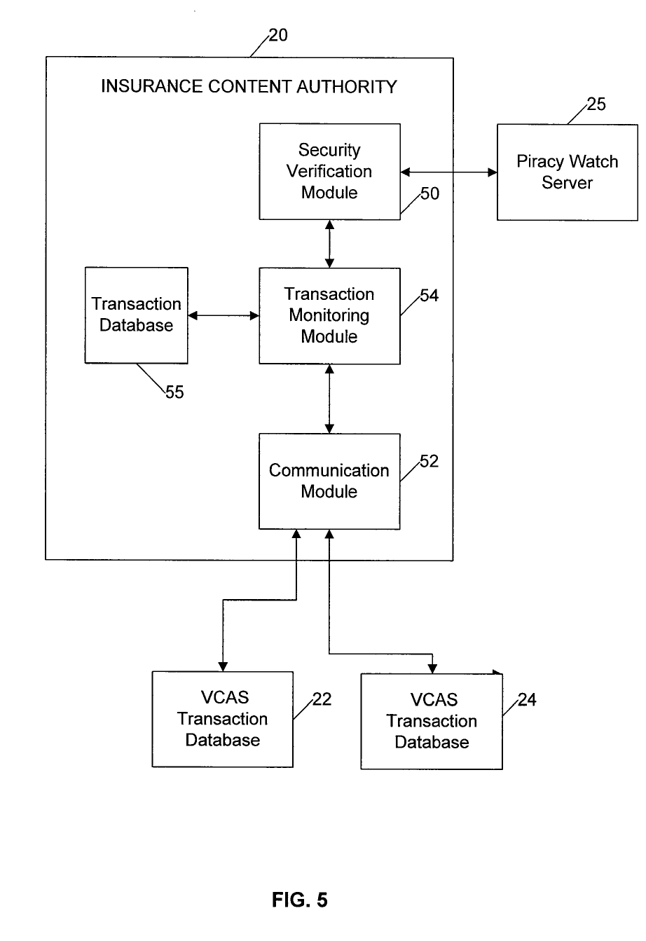

As illustrated in FIG. 5, the insurance content authority 20 has a security verification module 50 which communicates with the piracy watch server 25, and a communication module 52 which communicates with the VCAS transaction data base 22 of each digital content provider for which the piracy insurance is provided, and with the VCAS transaction data bases 24 of each distributor associated with the insured digital content provider. In another embodiment, the module 52 may communicate only with the VCAS data bases 22 of the digital content providers. A transaction monitoring module 54 is connected to the communication module 52 and to the security verification module 50. A transaction data base 55 connected to the transaction monitoring module stores transaction packages regarding distribution of insured digital content files received by module 54 from the digital content provider VCAS data bases. Data base 55 also contains a list of insured digital content files (such as movies or other types of insured digital content) which are to be monitored by the system. The insurance content authority communicates with the VCAS data bases 22 illustrated in FIG. 1 in order to monitor the protection provided to the insured digital content files in the list in its data base. In this case, the list is provided by the piracy insurance provider 10 and an updated list is provided as new insurance policies are issued. The insurance content authority may provide periodic reports to the piracy insurance provider on the security status for each insured digital content file.

In one embodiment, the movie studio VCAS 44 creates and issues a unique digital certificate to each distributor with which it is associated, i.e. each distributor which has entered an agreement with the movie studio to receive movies from that studio. Movies or other entertainment productions are then made available to the distributor through a user interface. The distributor sends requests for movies from VCAS 44 to VCAS 35. On receipt of a request for a particular movie or insured digital content file, VCAS 35 creates a transaction identifier or payload for the distributor request, which may identify the requesting distributor, time and date of the request, movie title, or the like. The transaction payload is then sent to VCAS 44. The VCAS 44 signs the transaction payload with a digital signature identifying the unique digital certificate for that distributor, and a package containing the original transaction payload and the digital signature is sent back to the VCAS 35 and stored in the studio's VCAS data base 22. This is proof that a unique distributor certified by the movie studio requested that particular movie. The digital signature is legal proof that the transaction occurred. The VCAS 35 then sends the decryption key for the movie to the distributor, followed by the encrypted movie accompanied by the encrypted payload containing the transaction identifier. A similar procedure is followed when the distributor sends a copy of the movie to a subscriber, with a second payload which identifies the requesting subscriber attached to the movie and a corresponding transaction package stored in the VCAS data base 24 in this case, as described above in connection with FIG. 3.

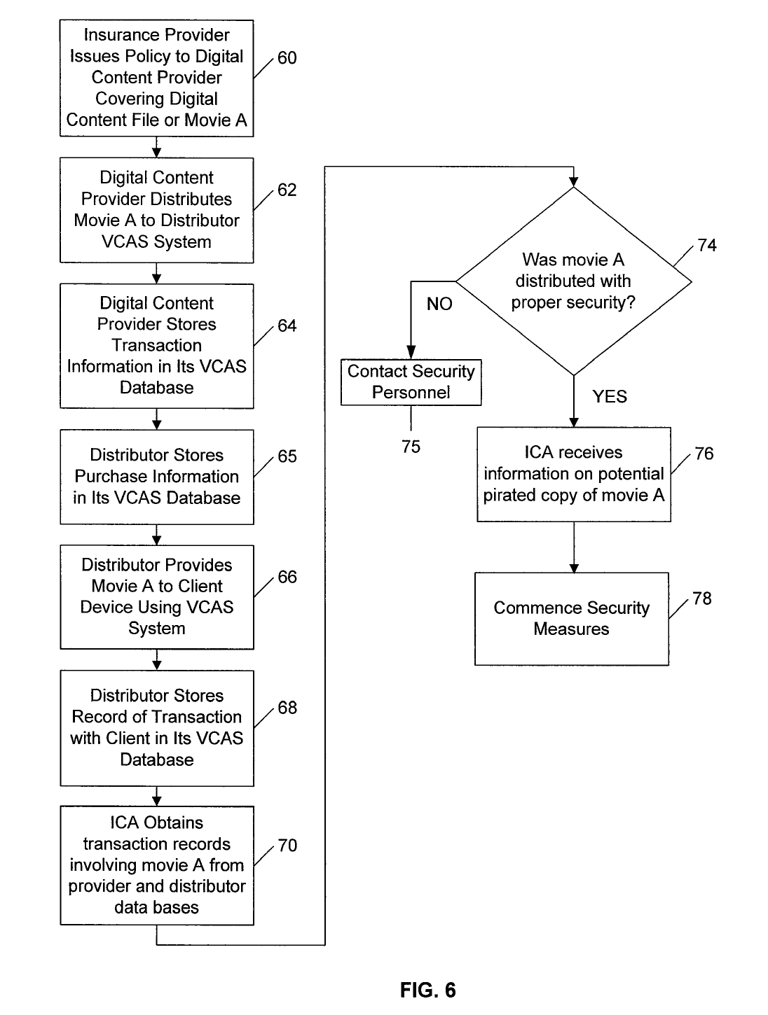

In the illustrated embodiment, each VCAS 35 and 44 sends each stored transaction package (transaction identifier and digital signature) for an insured movie to the ICA 20, and the ICA 20 stores all transaction packages for each insured movie in transaction database 55. In one embodiment, ICA 20 may also analyze transaction packages for proper security measures on receipt. In another embodiment, the ICA 20 simply stores each transaction package and only investigates the package further if it receives an indication of a potential pirated copy of the movie concerned, as described in more detail below in connection with FIG. 6. In another embodiment, ICA 20 may communicate with the VCAS 35 of each insured digital content provider 12 only, and receives and stores transaction packages associated with insured digital content files from the VCAS data base 22. The stored transaction packages may be analyzed for proper security measures and valid digital certificates on receipt, or may be stored for later analysis in the event that a potential pirated copy of the insured digital content file is located. In any of these embodiments, stored transaction packages may be indexed according to insured digital content files and/or insured content providers. The ICA 20 also contains stored digital certificates associated with content providers and content distributors.

When a pirated copy of an insured movie is detected, the watermark payload associated with that copy can be analyzed to determine the digital certificate associated with any digital signature, and transaction packages associated with the distributor which received that copy which are stored at ICA 20 can then be analyzed to verify the transaction path and determine if proper security measures were used. This may help in identifying the source of a security breach or determining whether a sophisticated hacker was involved.

FIG. 6 illustrates one embodiment of a method for auditing or monitoring network components to determine whether the various systems are operating correctly. This allows the piracy insurance provider 10 to manage the risks associated with issued piracy insurance policies. Although FIG. 6 illustrates the monitoring method for one insured movie A, the same procedure is carried out for any other insured movies. As illustrated in FIG. 6, piracy insurance provider 10 issues a piracy insurance policy to a digital content provider 12 such as a major motion picture studio (MMPS) in step 60. The MMPS may desire such insurance in view of an upcoming release of a motion picture. The insurance policy provides piracy insurance against losses due to piracy or theft of a digital content file such as a movie or motion picture A. The digital content provider receives requests for movie A from one or more distributors and distributes one or more encrypted copies of movie A to the VCAS systems 44 of a number of distributors 14 (step 62) using the security measures provided by its own VCAS system 35, as described in more detail above, and stores a corresponding record (transaction package) in its VCAS data base 22 (step 64). The distributor has a valid PKI certificate stored at the studio VCAS 35 in order to request movies from content provider 12, and sends a digital signature to the VCAS 35 in order to receive the decryption key and the encrypted movie. As noted above, this digital signature is stored as part of the transaction package in the VCAS data base 22.

Each distributor stores purchase information for movie A in its VCAS data base 24 (step 65), and provides encrypted copies of movie A to its clients or subscribers 15 for viewing on request, using its VCAS system 44 (step 66). The distributor stores a record of each client transaction package involving movie A in its VCAS data base 24 (step 68). Each client transaction package stored in the VCAS data base 24 includes a digital signature using the unique digital certificate assigned by the VCAS 44 to the requesting subscriber, and provides a record of a subscriber or client watching movie A.

The transaction monitoring module 54 of ICA 20 obtains transaction packages or records regarding movie A from the provider or studio VCAS data base 22 and from each distributor's VCAS data base 24, and stores these packages in data base 55 (step 70). Such packages may be sent by each VCAS data base 22 and 24 to the ICA 20 automatically each time they are created, or may be sent at periodic intervals. The VCAS data bases may have a list of insured movies of digital content provider 12, and may be programmed to send transaction packages involving any of the movies in the list to the ICA 20, either as such transactions occur or at periodic intervals.

In another embodiment, transaction packages are only sent to the ICA if the ICA specifically queries the VCAS data bases 22 and 24 for all transaction packages regarding a certain movie, such as movie A.

In step 74, the ICA transaction monitoring module and security verification module determine whether movie A was distributed with proper security. This may be done in various ways, for example by checking that each transaction package indicates proper security measures, such as watermarks and digital signatures associated with valid digital certificates. The ICA may validate the transaction path of movie A from VCAS 35 to VCAS 44 and from VCAS 44 to a client by comparing information in the stored transaction packages for each stage of the distribution path. In this method, the transaction monitoring module tracks and correlates distributor requests and corresponding provider distribution for each insured digital content file, and provides reports on security breaches to the insurance provider. If a potential security breach or lack of proper security measures is detected, a report may be generated and security personnel may be contacted to take appropriate security measures (step 75). In step 76, the ICA receives information regarding a potential pirated copy of an insured movie, either from piracy watch server 25 or outside services. Security measures are then commenced (step 78). Such security measures may include checking the watermark associated with the pirated copy, and comparing the watermark information with information in stored transaction packages involving the distribution of that copy from the digital content provider 12 to the identified distributor 14, and from the distributor 14 to a client device 15 (if the watermark on the pirated copy indicates that such distribution has occurred). If this analysis indicates that the movie was distributed properly at the studio level, the location of a pirated copy may indicate that a sophisticated hacker has broken the security measures, and further investigation and changing of the existing security measures may be required.

In one embodiment, steps 74 and 76 may be reversed, i.e. the ICA 20 only investigates the stored transaction packages for movie A if and when it receives information on one or more pirated copies of movie A. The step of determining whether movie A was distributed with proper security then comprises comparing the transaction package records only after a potential security breach is found (in the form of a pirated copy). This step then comprises comparing the stored transaction packages with the watermark or payload of the pirated copy of movie A. If all indicators are that the movie was distributed with proper security at the studio level, i.e. the studio was not the source of the breach, the pirated copy may have been obtained in some other manner, such as hacking. The ICA also generates periodic reports on potential security breaches and the results of any investigation of such breaches.

The steps taken on detection of a potential security breach may include revoking of insurance policies if the security breach cannot be contained, or changing the premium associated with the policy dependent on the terms and conditions of the policy. If adequate security is found in the distribution chain from the movie studio or content provider to the distributor, security is validated for that particular transaction. Periodic reports may be transmitted by the ICA for each movie or digital content file in its list to indicate whether or not security breaches have been found for that movie.

Using a network of Internet-based software and data mining techniques, the piracy watch server 25 scans the Internet for potential digital piracy and copyright infringement. All common mediums are supported such as peer-to-peer file trading communities, internet relay chat (IRC) networks, websites, file transfer protocol (FTP) sites, and newsgroups. A continuously updated list of potential acts of digital piracy is cross referenced against a database of client assets. In this example, the client assets being monitored by the piracy watch server include insured movie A, as well as any other movies for which the insurance provider has issued piracy insurance. The insurance provider periodically transmits a list of insured movie titles to the piracy watch server, and the piracy watch server stores the list in a data base and continuously monitors the Internet and known piracy sites for these titles. The piracy watch server 25 uses advanced heuristics, self-adapting searches, neural search algorithms, and probability ranking formulas to detect piracy.

If no security breaches are found by the piracy watch server, then it can be assumed that security breaches, if they exist, are relatively well contained. The ICA then returns to step 70 to continue monitoring the provider and distributor VCAS data bases for transactions involving movies covered by the insurance provider's piracy insurance policies.

The security measures initiated in step 78 may include requests to the piracy watch server for how many breaches were detected, who was the originator, what actions have been taken so far, and the like. The ICA may also have policies in place that automatically contact the VCAS systems 35 and 44 in the event of a security breach, and issue commands to stop further issuance of content.

In the above description of the method illustrated in FIG. 6, the ICA monitors and obtains transaction packages from VCAS data bases at both the content provider 12 and the content distributor 14. However, in an alternative embodiment, the ICA may monitor and obtain transaction packages from the VCAS data bases of insured content providers only, and does not look at any information in the distributor VCAS data bases. In this embodiment, the method is similar to that described above with the exception that only transaction packages obtained from VCAS data base 22 are investigated by the ICA, either routinely or as a result of detection of a potential pirated copy.

The web-based crawler of piracy watch server 25 continuously monitors for violations or piracy of any selected movie titles, by searching against title and content and by checking for the presence of a watermark in any suspected pirated copy. Any violations are matched and cataloged 24×7×52, along with identifying criteria, such as username, IP address, file path, and unique watermark information. The piracy watch server continues to monitor each site where an infringement or violation is detected until pirated assets are removed from the site.

New titles can be monitored to detect piracy in its early stages and monitor proliferation across the Internet, to identify pre-release and screener copies, and to identify and monitor high risk pirate sites before they can adversely affect sales.

The piracy watch server monitors web sites for evidence of protected movie files. This may comprise automated monitoring services for the following types of Internet sites and services:
Peer to Peer
Auction Sites
Internet Relay Chat IRC (Chat)
File Transfer Protocol. (FTP) files transmitted over the Internet
Hyper Text Transfer Protocol (HTTP) or web browsing
User's Network or newsgroup Bulletin Boards (USENET)

Watermarks are added to movie files as they move through the distribution chain of FIG. 1 to identify both the sender and the recipients, and the watermark payloads are encrypted as an indication of authenticity. As noted above, if a protected movie file is detected on the Internet, security measures are taken (step 78). This may involve forensic analysis of movie files found on the Internet to find and verify watermark payloads. The watermark payload in turn provides an indication of the origin of the movie file, and the person responsible for the piracy is identified. Appropriate action can then be taken. This may comprise notifying the responsible party by email, registered mail, and/or telephone calls, and disconnecting service if the party does not take action to stop any further unauthorized distribution of the movie file. If further acts of piracy by the same party are detected after such warnings, additional action such as mailed invoices and payment demands, legal complaints, and taking other action to recover damages and losses.

The system of FIGS. 1 to 6 allows insurance companies and others to assess risks involved in distribution of digital content, and to receive reports of security breaches both within the normal secure distribution chain and on public networks. This may make it more feasible to issue piracy insurance policies to the owners of digital content against losses due to piracy. The ICA 20 allows piracy insurance provider 10 to audit each component of the network in order to determine whether the components are operating correctly. In one embodiment, piracy insurance provider 10 may knowingly release copyrighted digital content into the public domain for audit purposes, in order to measure the effectiveness of the security systems that are in place. If the digital content is found by the piracy watch server 25, then the insurance company has evidence that all systems are operating correctly. If the content made available to the public for auditing purposes is not detected by the piracy watch server, then the insurance company knows that action needs to be taken in order to improve the piracy watch system.

The ICA 20 may also be used to query the various systems on the network in order to calculate statistics and assess the risks for insuring the distribution of certain forms of content over the network. ICA 20 is used to manage the risks that are associated with insurance policies that have already been issued, as illustrated in FIGS. 1 to 6 and described above. If certain geographical areas or types of digital content are associated with an increased risk of security breaches, the sophistication of the encryption of certain types of content that are being transmitted to certain geographical locations may be increased. The increased risk may be identified, for example, as a result of previous security breaches found in the same geographical areas or involving similar content types.

The piracy insurance provider may be configured to issue policies to content providers on-line and likewise revoke policies on-line immediately after a violation of the terms and conditions for the policy have been detected.

The insured content authority (ICA) or security monitoring system 20 is an auditing tool that provides a piracy insurance provider with audit access to a digital content distribution system. The ICA communicates with each stage of the content distribution system in order to determine whether the insured content is appropriately protected.

Digital piracy does not always take place on the consumer end of the distribution supply chain. Such piracy often takes place within the production or post-production work flow. In addition, piracy can also take place somewhere within the distribution supply chain as media information is moved from one location to another. Examples of piracy within the distribution supply chain is where an employee for an “overnight” transportation company “borrows” a DVD or a tape for a few hours after it has been picked up from an encoding house and before it is sent on its way to the intended (and authorized) distribution partner. If copies of such pirated digital files are located by the piracy watch server in the system described above, the piracy insurance provider can determine that such a security breach has taken place.

Producers and investors in the world of digital content production and distribution have a number of issues they consider to be important. One issue is the quality of the content provided to a target audience. Content with the highest production quality usually receives the highest revenues. When producers and investors weigh their investment against the possible threat of hacking and piracy, the world of digital content creation may suffer if investors shy away due to such threats. However, state-of-the-art cryptography, steganography, forensics, and other security technologies have the potential to fight against piracy in the future. It may be possible to protect digital information in such a secure fashion that the cost to hack the content is greater than the value of the content itself. The piracy insurance system described above may use some or all of such security technologies in the distribution chain for insured digital content files.

In the embodiment described above in connection with FIGS. 1 to 6, the digital piracy insurance provider issues piracy insurance policies to content providers and has a security monitoring system or ICA which monitors network devices in the distribution chain from the provider to the client device for adequate security measures. This piracy insurance system insures against piracy of digital content distributed electronically over one or more networks. However, there are other situations during creation and distribution of movies and other entertainment media when hacking or piracy may occur, and the system may be expanded to include coverage for one or more of such additional situations. Below is a list of the various situations and the types of hacking/piracy that may be encountered:
Content Production: Theft of Rough Cuts or Dailies
Post Production: Theft during the creation of special effects or animation
Post Production: Theft during the editing or authoring of the motion picture
Theatrical Release: Theft of Film Prints or Digital Cinema Files
Electronic Distribution: Theft of the digital streams or downloads
Physical Distribution: Theft and compromise of CDs, VCDs, DVDs, HD-DVD, Blu-Ray and other formats
Broadcast: Theft of data captured from a broadcast channel

In alternative embodiments, the digital piracy insurance provider may initiate other security measures for one or more of the stages listed above in the creation and distribution of digital content files. For example, some or all of the equipment used to produce and distribute the content may be provided with security means such as (but not limited to) encryption, state-of-the-art cryptographic functions and methods, watermarking (various steganographic means and methods), copy control, analog protection (if analog input or outputs are allowed to exist), and other security means. Some or all of the following equipment may be provided with security means in alternative embodiments of a piracy insurance system:

1. Content Creation Side:
Cameras
PCs
Scanners
Rendering devices
Recorders
Storage Devices
Post-Production Gear
Other devices used to create digital contents.

2. Content Preparation Side:
Editing Equipment
Authoring Equipment
Coloring Equipment
Mixing Equipment
Duplicating Equipment
Dubbing Equipment
Equipment used to make adjustments, alterations, improvements, or otherwise prepare the content for its ultimate audience.

3. Distribution Side:
Web sites and web services
File Transfer Protocol (FTP) services
Satellite uplinks and downlinks
Streaming services
Download services
Physical media distribution means and services
Other transportation means, services, and/or offerings.

4. Playout Side:
Media Players
PC Players
Set-top-boxes
Television sets
Media recording mechanisms
Home Gateway devices and mechanisms
Mobile devices
Wireless devices
Stationery devices
Other devices used by subscribers, consumers, or business-to-business partners in order to ultimately “play” the content.

5. Consumer Side:
Digital cameras
Software or hardware editing/authoring products
Optical disc ripping products
Tape extraction products
Other consumer-oriented products that can assist hackers and pirates with the goal of ultimately gaining access to protected digital contents.

One example of the use of a piracy insurance system is as follows. A producer decides he wants to begin production on a high-concept movie project. He obtains agreements from qualified writers, actors and directors in order to provide him with a desirable end-product. The producer may then approach a major movie studio in order to secure the distribution channel for the movie once finished. In discussions between a prospective producer and a major studio, the studio may be concerned if the movie is the type that is attractive to digital pirates. The theatrical release of the movie may be negatively impacted by any significant occurrence of digital piracy. Since the budget for such a movie project is large, the risk of piracy during the theatrical release could reduce the expected revenue to an unacceptable level. A studio may turn down the project in some cases if it perceives the risk of loss to be too high.

The studio might be more prepared to fund such a project if the movie project can be insured against the risk of piracy during the period when it is released theatrically, so that the risk of losses due to piracy during the theatrical release could be mitigated. The producer in this case can approach piracy insurance provider 10, and the provider 10 issues a policy insuring the movie during the theatrical release as long as designated security procedures are followed in order to protect the movie (and its component parts) during the production, post-production, and the early distribution phases of the project.

If the required security procedures to protect the movie (and its component parts) are not followed, the insurance policy may be terminated. Security solutions, technologies, and services are deployed as per the requirement of the insurance company in order for the insurance policy to remain active and intact. If there is no trace of piracy on release of the movie, the insurance company keeps its premiums and the producer and the studio are compensated with the results of the box-office revenues (and all ancillary revenue streams).

If some piracy is identified during the theatrical release on a number of peer-to-peer internet sites in various parts of the world, the insurance company notifies anti-piracy personnel to download all traces of the movie and to forensically identify the source of the leakage. In addition, these anti-piracy personnel can notify the hosts for such peer-to-peer traffic and ask them to remove the movie from their list of offerings. After the movie copies are removed from these sites, the insurance company determines the number of downloads that might have taken place and estimates the level of damage done to the owners of the “rights” to this movie. The insurance company then settles with the producer and/or the studio by paying an amount as agreed with in the insurance policy. The insurance company may also take steps to determine the source of the leakage and take actions to make sure the same leakage does not occur in the future.

In a worst case scenario, the detected piracy may be widespread. In this scenario, after careful analysis, the leakage is coming from everywhere. The insurance company may still try to involve their anti-piracy personnel in identifying the source or sources of the leak, and they also return the lost revenue to the producer and the studio, as agreed in the insurance policy.

In one embodiment, a piracy insurance provider may terminate an insurance policy on the day that content is made available to the public on physical media such as CDs, DVDs, tapes, or other physical media, which is much harder to secure. As a motion picture drops in value (as a function of its age) and as less-secure means are used in these later release window opportunities, the insurance policy may expire. In alternative embodiments, the insurance policy can exist for a longer period of time or in perpetuity.

If a content owner or insured digital content provider has complied with all of the rules and policies that are required by the piracy insurance company, the owner may still experience the loss of potential revenues as a result of digital piracy. If the owner has purchased piracy insurance for the digital content, they can submit a claim to the insurance company as is the normal case with other types of insurance that are issued today. After a review of the specific information in the case, the insurance company can issue appropriate damages to the digital content owner and, in parallel, initiate legal actions against the people responsible for the digital piracy, if they can be identified.

Digital piracy and computer hacking currently runs rampant. The piracy insurance method and system in the embodiments described above provides some level of security for owners of digital content such as movies and the like. The security measures provided by the VCAS systems may include encryption, cryptography, and steganography. This may enable more digital content (and higher value digital content) to be made available to the public at large using secure networked systems. All types of digital content are potentially exposed to disasters. The piracy insurance provider can spread the risk of digital piracy over a large number of potential policy holders who employ state-of-the-art security means to protect their digital contents from the point of its inception to the point of its ultimate delivery. As consumers become more comfortable with using the latest security measures, insurance companies can accept the risk of disaster spread over a large number of potential policy holders (content owners).

Those of skill will appreciate that the various illustrative logical blocks, modules, circuits, and algorithm steps described in connection with the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method of monitoring the security of digital content files during distribution, which comprises:
issuing a piracy insurance policy from a piracy insurance provider to a digital content provider for at least one digital content file;
receiving first transaction information packages from a security system of the digital content provider for each distribution of the insured digital content file from the digital content provider to a content distributor;
storing the first transaction information packages in a data base associated with the piracy insurance provider;
analyzing each first transaction information package to determine whether insured digital content files distributed by the content provider were secured with a security device having a predetermined level of security selected by the piracy insurance provider; and
changing the conditions of the piracy insurance policy on detection of distribution of the insured digital content file without the predetermined level of security.

2. The method of claim 1, wherein the step of changing the conditions of the piracy insurance policy comprises changing the premium charged for the policy.

3. The method of claim 1, wherein the step of changing the conditions of the piracy insurance policy comprises revoking the policy.

4. The method of claim 1, wherein the security device is selected from the group consisting of encryption, watermarking, digital signatures, and digital certificates.

5. The method of claim 1, wherein the security device comprises an encrypted payload using a digital certificate which identifies at least one party to a transaction involving the selected digital content file.

6. The method of claim 5, wherein the digital certificate is a public key infrastructure (PKI) digital certificate.

7. The method of claim 1, wherein the security device includes a digital signature of a content distributor which received the insured digital content file from the content provider.

8. The method of claim 1, further comprising obtaining second transaction information packages from a security system of a content distributor which receives insured digital content files from the content provider for each distribution of the insured digital content file from the content distributor to a subscriber, storing the second transaction information package, analyzing each second transaction information package to determine whether insured digital content files distributed by the content distributor were secured with a security device having a predetermined level of security selected by the piracy insurance provider, and changing the conditions of the piracy insurance policy on detection of distribution of the insured digital content file from the content provider or the content distributor without the predetermined level of security.

9. The method of claim 1, further comprising notifying security personnel if a digital signature corresponding to a valid digital certificate of a participant in the transaction is not found in a transaction package.

10. The method of claim 1, further comprising searching at least one public network for pirated copies of the insured digital content file.

11. The method of claim 10, further comprising extracting information from the security device associated with a pirated copy which identifies the originator of the pirated copy.

12. The method of claim 11, wherein the extracted information comprises a transaction identifier identifying a party to an authorized transaction involving the selected digital content file extracted from an encrypted watermark payload attached to the pirated copy of the digital content file.

13. The method of claim 1, further comprising storing transaction packages for each distribution of the insured digital content file at data base associated with the piracy insurance provider, searching at least one public network for pirated copies of the selected digital content file, comparing the stored transaction packages to information obtained from a watermark payload in any detected pirated copy of the selected digital content file in order to determine a potential source for the pirated copy, and increasing the level of security associated with distribution of an insured digital content file by a digital content provider if a predetermined number of pirated copies of the insured digital content file are detected.

14. A security monitoring system for monitoring the security of an insured digital content file during distribution, comprising:
a communication module which communicates with a first security system associated with a digital content provider and with a second security system associated with a digital content distributor;
a transaction monitoring module associated with the communication module which queries the security systems to obtain transaction packages corresponding to delivery of a requested insured digital content file from the digital content provider to the distributor and which stores the transaction packages;
a piracy watch module connected to a public network which searches the network for pirated copies of the insured digital content file and issues a piracy report to the transaction monitoring module if a pirated copy is detected;
a security verification module associated with the transaction monitoring module which extracts transaction information including a digital signature identifying a digital certificate of a party to the transaction from the stored transaction packages on receipt of a piracy report and compares the transaction information with a digital signature in a watermark payload of pirated copy of the insured digital content file in order to identify a potential source for the security breach; and
a piracy insurance module linked to the security verification module which issues piracy insurance policies to content distributors to cover distribution of insured digital content files, receives reports on security associated with the distribution of insured digital content files from the security verification module, and adjusts insurance policies based on information received from the security verification module.

15. The security monitoring system of claim 14, wherein the piracy watch module has a communication module which sends information on any detected pirated copies of the insured digital content file to the security verification module.

16. The system of claim 14, wherein the security verification module includes a query module which queries the piracy watch module for information on any detected pirated copies of an insured digital content file.

17. The security monitoring system of claim 14, further comprising a data base module containing a list of insured digital content files which are monitored by the transaction monitoring module.

18. The security monitoring system of claim 14, wherein the security verification module further comprises a report generator which generates reports of any security breaches detected for each insured digital content file monitored by the transaction monitoring module.

19. A method of monitoring the security of an insured digital content file during distribution, comprising:
communicating with a security system associated with a digital content provider and a security system associated with a digital content distributor;
obtaining a first transaction package from the provider involving a transfer of an insured digital content file from the provider to the distributor in response to a request from the distributor, the transaction package including a digital signature of the distributor confirming the request, the digital signature associated with a unique digital certificate for the distributor provided by the digital content provider;
obtaining a second transaction package from the distributor involving distribution of an insured digital content file from the distributor to a subscriber in response to a request from the subscriber, the transaction package including a digital signature of the subscriber confirming the request, the digital signature associated with a unique digital certificate for the subscriber provided by the digital content distributor;
storing the first and second transaction package in a data base of an insured content authority;
monitoring a public network for potential pirated copies of the insured digital content file;
generating a security breach signal if a pirated copy is located;
analyzing the contents of the first and second transaction packages at the insured content authority in response to a security breach signal and comparing the digital signatures in the transaction packages with a digital signature of a watermark payload associated with the pirated copy;
using the results of the comparison to determine a potential source of the security breach; and
generating a report of the security breach including the potential source of the breach.

20. The method of claim 19, further comprising issuing piracy insurance policies to digital content providers for selected digital content files, and modifying the conditions of the piracy insurance policy covering a selected digital content file in response to a predetermined number of security breaches.

21. The method of claim 20, wherein the step of modifying the insurance policy conditions is selected from revoking the policy and increasing the premium for the policy.
